(19) United States
(12) Patent Application Publication
(10) Pub. No.: US 2007/0255714 A1
(43) Pub. Date: Nov. 1, 2007

(54) XML document permission control with delegation and multiple user identifications

(75) Inventors: Antti Laurila, Helsinki (FI); Miikka Poikselka, Espoo (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/415,005

(22) Filed: May 1, 2006

(51) Int. Cl. G06F 17/30

(52) U.S. Cl. 707/9

(57) ABSTRACT

A system and method for authorizing multiple User IDs to access the same XML document without manually granting access rights to multiple User IDs. According to the present invention, when a new XML document is created, a network entity automatically performs a search to the user information register and retrieves all of the associated public user identities for the user. Rights to perform all XML document management functions are then given to all associated user-specific public user identities in addition to the used XCAP User Identifier.

### FIELD OF THE INVENTION

The present invention relates generally to extensible markup language (XML) document permission control. More particularly, the present invention relates to XML permission control to accommodate multiple user identifications.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The Open Mobile Alliance (OMA) is an industry association that develops service enabler standards for wireless and fixed information and telephony services on digital mobile telephones and other wireless devices and fixed devices. OMA has defined a generic framework for group and list management that is referred to as XML Document Management (XDM). XDM is based upon XML Configuration Access Protocol (XCAP).

XDM defines a common mechanism that makes user-specific service-related information accessible to the different service enablers that require them. Such information is expected to be stored in the network where it can be located, accessed and manipulated (i.e., created, modified, retrieved, deleted, etc.) by authorized principals. The client is able to identify elements inside one XML document and modify only those documents which are needed.

Documents accessed and manipulated via XCAP are stored in logical repositories in the network, which are referred to as XML Document Management Servers (XDMS). The Shared Group XDMS stores group documents, which can be reused by several enablers. For example, a Push to Talk Over Cellular (PoC) server accesses a Shared Group XDMS to obtain a Shared Group document, which provides the information of the group, e.g., member lists, conference types, supported medias etc. The XML Document Management Architecture (release version 2.0), is depicted in FIG. 1.

In the XDM version 1.0 architecture, only the owner of a document can access and modify it. XDM version 2.0 includes a delegation function, which makes it possible for one principal to authorize other principals to perform selected operations on their behalf. For this purpose, a default associated access document is created when the document is created. The default permissions deny any entity other than the creator of the document to perform document management functions (i.e., create, retrieve, copy, delete, modify, forward, suspend, resume, search, and delegate functions.)

Unfortunately, problems occur when the same user has multiple public user identities in his or her subscription (e.g. sip:ronald.underwood@example.com, tel:+358991234567, sip:ronnie@home.net). These identities are used to identify the user when communicating with other users or with network entities. When a public user identity is used as a path element in an HTTP uniform resource identifier, that is associated with each user served by the XCAP server, it is called a XCAP user identifier (XUI). If such a user wants to use the same document with each of these XUIs, issues arise because each XDM document is identified and named per XUI. An example of such a document address is shown as follows in a tree format: http://xcap.example.com/services/resource-lists/users/sip:ronald.underwood@example.com/friends.xml

In this address, “sip:ronald.underwood@example.com” is the document owner's XUI. In this situation, the user cannot use this document via his other XUIs (public user identities) unless he first grants access rights to the other XUIs (public user identities) as well.

It is conventionally assumed that a user is using single XUI when executing XDM operations. It is also assumed that the same identity is used both in the XDM phase and the Session Initiation Protocol (SIP) communication phase. However, in the XDM 1.0 timeframe, there can be situations available which allow the usage of multiple XUIs. In these situations, all of the XUIs must keep their own copy of the document under their XUI in the user tree. This can create a number of problems, including the problem of how to synchronize this data and keep all references alive, as there is no defined method enabling a system to correctly identify these associated XUIs. When owned copies are kept, it is not possible to use the same group identity with multiple public user identities in SIP communication.

### SUMMARY OF THE INVENTION

The present invention provides a system and method for addressing the difficulties discussed above. According to the present invention, when a new XML document is created, the rights to perform all XML document management functions are given to all associated user-specific public user identities, in addition to the public user identity used as a XUI. These various embodiments of the present invention improve usability and enable the more flexible use of public user identities.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of the XML document Management Architecture Release version 2.0;

FIG. 2 is a flow chart showing the implementation of a first embodiment of the present invention;

FIG. 3 is a flow chart showing the implementation of a second embodiment of the present invention;

FIG. 4 is a flow chart showing the implementation of a third embodiment of the present invention; and

FIG. 5 is a schematic representation of circuitry that can appear in an electronic device involved in the implementation of the present invention.

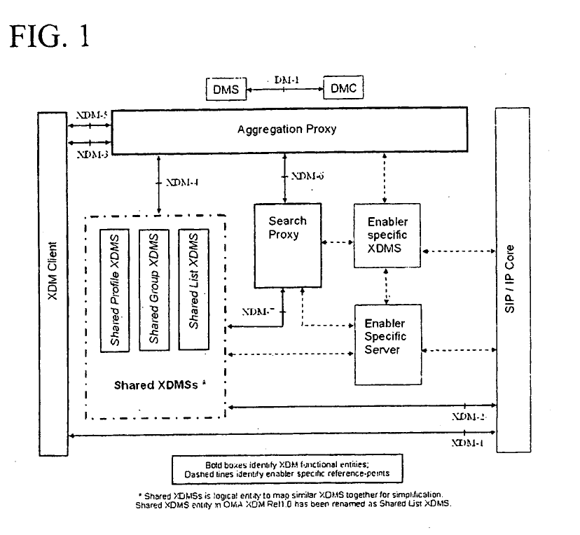

### DETAILED DESCRIPTION OF THE PREFERRED EMBODIMENTS

The present invention provides systems and methods for authorizing multiple XUIs to access the same XML document without manually granting access rights to multiple XUIs. According to the present invention, when a new XML document is created, rights to perform all XML document management functions are given to all associated user-specific public user identities in addition to the used public user identity as a XUI.

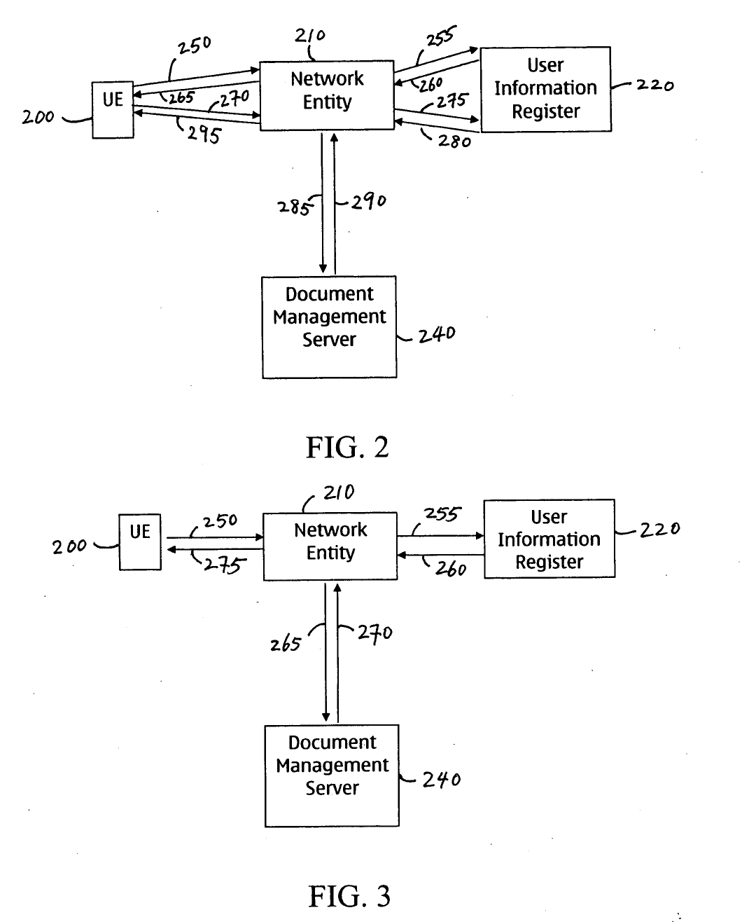

FIG. 2 is an example of how the first embodiment of the present invention is implemented. FIG. 2 shows user equipment 200, a network entity 210, a user information register 220 and a document management server 240. In FIG. 2, it is assumed that a user has several public user identities (e.g., sip:ronald.underwood@example.com, tel:+358991234567, sip:ronnie@home.net). When the user creates an XML document, (e.g., a shared list of all of the user's friends for the purpose of communicating with different applications) this XML document is stored in the document management server 240 under the XUI which was used when the user created the list.

When the user equipment 200 (for example, a smart phone manufactured by Nokia Corporation) initiates an activity to create an XML document, the user equipment 200 automatically sends to the network entity 210 (for example, an aggregation proxy) a request for all of the public user identities associated with the current user. This request is represented at 250 in FIG. 2. The network entity 210 receives the request from the user equipment 200 and authenticates the request. Authentication information is stored in the user information register 220 (e.g. the home subscriber server (HSS) in IMS architecture). The network entity 210 can retrieve the user's public user identities from the user information register 220. The retrieval of the user's public user identities is represented at 255 and 260 in FIG. 2. In this example, the user information register 220 returns ‘tel:+358991234567’ and ‘sip:ronnie@home.net’ as associated public user identities. After obtaining this information, the network entity 210 sends all of the public user identities associated with current user to the user equipment 200. The transmission of the public user identities to user equipment is represented at 265 in FIG. 2.

After receiving all of the public user identities, the user equipment 200 uploads the content of the XML document (for example, a list of his friends) in XML-format, together with all of the public user identities associated with this user to the network entity 210. This upload request is shown at 270 of FIG. 2. After receiving the content of the XML document and a list of public user identities, the network entity 210 performs authentication, which is represented at 275 and 280 in FIG. 2. After successful authentication, the network entity 210 routes the XML document creation request, together with associated public user identities, to the document management server 240, based on an Application Unique ID (AUID) that differentiates resources accessed by one application from another application. This is represented at 285 in FIG. 2. The document management server 240 creates a document under XUI , e.g., ronald.underwood@example.com, together with an associated access document. Normally, default permisions defined in an associated access document deny any user other than the creator of the document to perform document management functions (e.g., create, modify, delete, search, etc.) In this embodiment of the present invention, however, all rights with regard to this document are automatically delegated to associated public user identities (e.g., create, modify, delete, search, etc.) so that the user (via the user equipment 200) can later use and modify his own document with other XUIs as well, without having to manually delegate access rights to that document. The document management server 240 responds to the user equipment 200, via the network entity 210, with a status OK message. This message, from the document management server 240 to the network entity 210, is represented at 290 and from the network entity 210 to the user equipment 200 at 295. Similar types of procedures can be performed whenever a user creates any type of new XDM document, regardless of whether the data management server is a Shared List XDMS, a Shared Group XDMS, a PoC XDMS, an Instant Messaging XDMS (IM XDMS), a Presence XDMS or Resource List Server XDMS (RLS XDMS), etc.

With the embodiment depicted in FIG. 2, the user can access the XML document without manually granting access to all his public user identities. This is important because, in a typical wireless service provider network, there can be large number of network entities that do not have such functionality enabled. This embodiment enables the user to utilize the present invention even though his wireless service provider may not have some or all of the network entity updated with this functionality.

FIG. 3 is an example of how a second embodiment of the present invention is implemented. FIG. 3 shows user equipment 200, a network entity 210 (for example, an aggregation proxy), a user information register 220 and a document management server 240 (for example, a Shared List XDMS).

In examining FIG. 3 below, it is assumed that a user has several public user identities (e.g., sip:ronald.underwood@example.com, tel:+358991234567, sip:ronnie@home.net). When the user creates a XML document (e.g. a list of friends of the current user) for communication with different applications, the list is stored in the document management server 240 under the XUI which was used when the user created the list. At 250 in FIG. 3, the user equipment 200 uploads the content of the XML document to the network entity 210. In this example, the identity sip:ronald.underwood@example.com is used as the XUI.

When the network entity 210 receives the request from user equipment 200, it needs to authenticate the request. Authentication information is stored in user information register 200 (e.g. the HSS in IMS architecture). During this process or immediately thereafter, the network entity 210 can download the user's public user identities from the user information register 200 that contains the user information, in this case the user information register 220. The requesting of the identities is represented at 255 in FIG. 3.

After obtaining requested identities (represented at 260 in FIG. 3), the network entity 210 adds public user identities to the request as a new information element. In this example, the user information register 220 returns ‘tel:+358991234567’ and ‘sip:ronnie@home.net’ as associated public user identities. After the authentication check and request of associated public user identities, the network entity 210 routes the request, with associated public user identities added on the request, to the document management server 240 based on an Application Unique ID (AUID) that differentiates resources accessed by one application from resources accessed by another application. This is represented at 265 in FIG. 3. The document management server 240 creates a document under XUI , e.g., ronald.underwood@example.com, together with an associated access document. Normally, default permisions defined in an associated access document deny any user other than the creator of the document to perform document management functions (e.g., create, modify, delete, search, etc.) In this embodiment of the present invention, however, all rights with regard to this document are automatically delegated to associated public user identities (e.g., create, modify, delete, search, etc.) so that the user (via the user equipment 200) can later use and modify his own document with other XUIs as well, without having to manually delegate access rights to that document. The document management server 240 responds to the user equipment 200, via the network entity 210, with a status OK message. This message is represented at 270 (from the document management server 240 to the network entity 210) and 275 (from the network entity 210 to the user equipment 200). Similar types of procedures can be performed whenever a user creates any type of new XDM document, regardless of whether the document management server is a Shared List XDMS 240, a Shared Group XDMS, a PoC XDMS, an Instant Messaging XDMS (IM XDMS), a Presence XDMS or Resource List Server XDMS (RLS XDMS), etc.

With the embodiment depicted in FIG. 2, the user can access XML document without manually granting access to all his public user identities. This is important because a great number people may still use an older phone that do not have the latest functionality. The second embodiment makes sure these group of people can still received the benefits discussed herein.

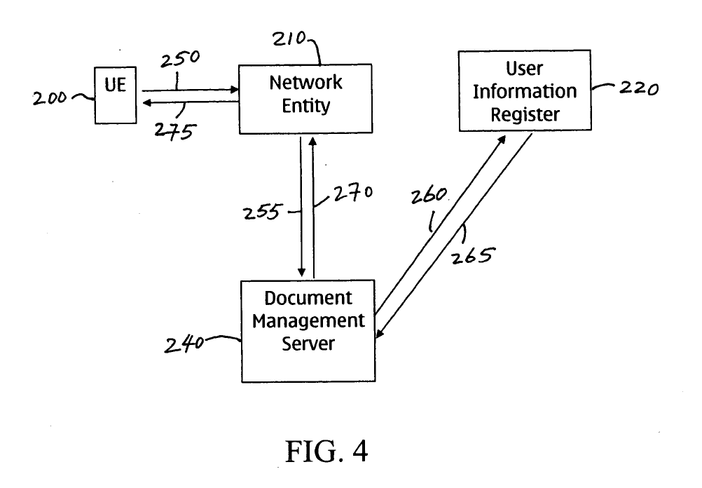

FIG. 4 is an example of how a third embodiment of the present invention is implemented. The embodiment depicted in FIG. 4 is similar in many respects to the embodiment shown in FIG. 3. As in the embodiment of FIG. 3, at 250 the user equipment 200 uploads the list of his friends in xml-format to the network. However, instead of the network entity 210 requesting the user's public user identities, this request is made by the document management server 240 at 260 in FIG. 4, after it has received a request 255 that is routed based on AUID via the network entity 210. The user information register 220 provides these identities to the document management server 240 at 265, In this example, the user information register 220 returns ‘tel:+358991234567’ and ‘sip:ronnie@home.net’ as associated public user identities.

After receiving associated public user identities at 265, the Document management server 240 creates a requested document under a XUI, e.g., ronald.underwood@example.com, together with an associated access document. Normally, default permisions defined in an associated access document deny any user other than the creator of the document to perform any document management functions (e.g., create, modify, delete, search, etc.). In this embodiment, however, all rights with regard to this document are automatically delegated to associated public user identities received from the user information register 220 at 265. This is done so that the user (via the user equipment 200) can later use and modify his own document with other public user identities as XUIs, without having to manually delegate access rights to those other XUIs beforehand. After the successful creation of a document, the document management server 240 responds to the user equipment 200, via the network entity 210, with a status OK message. This message is represented at 270 (from the document management server 240 to the network entity 210) and 275 (from the network entity 210 to the user equipment 200). Similar types of procedures can be performed whenever a user creates any type of new XDM document, regardless of whether the document management server is a Shared List XDMS 240, a Shared Group XDMS, a PoC XDMS, an IM XDMS, a Presence XDMS or RLS XDMS, etc.

With this embodiment of the present invention, the user can access XML document without manually granting access to all his public user identities. This is important because in a typical wireless service provider network, there can be a large number of network entities that do not have this functionality enabled and many people may still use older equipment that do not have the latest features. With this embodiment, however, these users can still receive many of the benefits discussed herein.

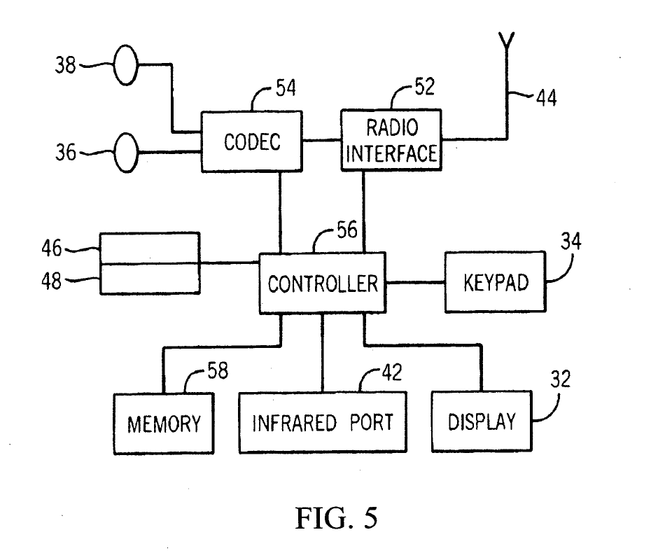

FIG. 5 shows the circuitry that can appear in one representative electronic device within which different aspects of the present invention may be implemented. It should be understood, however, that the present invention is not intended to be limited to one particular type of electronic device. The electronic device of FIG. 5 includes a display 32, a keypad 34, a microphone 36, an ear-piece 38, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones. The present invention is also applicable to fixed devices such as personal computers.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of providing automatic authorization to multiple user identities for the same XML document, comprising:
upon receiving a request from a user for creation of an XML document, downloading a list of public user identities for the user from a user information register; and
automatically delegating proper access rights for each identity in the list of associated public user identities.

2. The method of claim 1, wherein the list of public user identities is downloaded from the user information register to user equipment.

3. The method of claim 2, wherein the list of user identities is sent to the document management server by the user equipment, and wherein the document management server creates the requested document together with an associated access document which contains the public user identities and automatically delegates appropriate rights to the public user identities.

4. The method of claim 1, wherein the list of user identities is downloaded directly from the user information register to the network entity and is added to the request by the network entity to the document management server.

5. The method of claim 4, wherein the document management server creates the requested document together with an associated access document which contains the public user identities and automatically delegates appropriate rights to the public user identities.

6. The method of claim 1, wherein the list of user identities is downloaded directly from the user information register to a document management server, and wherein the document management server automatically delegates appropriate rights to the associated public user identities.

7. A computer program product, embodied in a computer-readable medium, for providing automatic authorization to multiple user identities for the same XML document, comprising:
computer code for, upon receiving a request from a user for creation of an XML document, downloading a list of public user identities for the user from a user information register; and
computer code for automatically delegating proper access rights for each identity in the list of associated public user identities.

8. The computer program product of claim 7, wherein the list of public user identities is downloaded from the user information register to user equipment.

9. The computer program product of claim 8, wherein the list of user identities is sent to the document management server by the user equipment, and wherein the document management server creates the requested document together with an associated access document which contains the public user identities and automatically delegates appropriate rights to the public user identities.

10. The computer program product of claim 7, wherein the list of user identities is downloaded directly from the user information register to the network entity and is added to the request by the network entity to the document management server.

11. The computer program product of claim 7, wherein the list of user identities is downloaded directly from the user information register to a document management server, and wherein the document management server automatically delegates appropriate rights to the associated public user identities.

12. A network entity, comprising:
a processor; and
a memory unit communicatively connected to the processor, including:
computer code for, upon receiving a request from a user for creation of an XML document, automatically obtaining a list of associated public user identities for the user; and
computer code for adding the list of associated public user identities to the XML document request.

13. A user equipment item, comprising:
a processor; and
a memory unit communicatively connected to the processor and including:
computer code for automatically obtaining a list of associated public user identities for a user of the user equipment; and
computer code for adding the list of associated public user identities to an XML document request being transmitted to a document management server.

14. A document management server, comprising:
a processor; and
a memory unit communicatively connected to the processor and including:
computer code for upon receiving a request for the creation of an XML document, automatically obtaining a list of associated public user identities for the user that requested the creation of the XML document; and
computer code for creating the requested XML document, the XML document including delegations of proper access rights for each identity in the list of associated public user public user identities.
